(19) United States
(12) Patent Application Publication
(10) Pub. No.: US 2021/0084864 A1
(43) Pub. Date: Mar. 25, 2021

(54) PORTABLE FLOATING ANIMAL CARRIER SYSTEM, RETROFIT SYSTEM, AND METHOD OF USE

(71) Applicants: Melissa Torres, Rehoboth, MA (US); Trisha Torres, Rehoboth, MA (US)

(72) Inventors: Melissa Torres, Rehoboth, MA (US); Trisha Torres, Rehoboth, MA (US)

(21) Appl. No.: 17/026,533

(22) Filed: Sep. 21, 2020

Related U.S. Application Data
(60) Provisional application No. 62/903,912, filed on Sep. 22, 2019.

(51) Int. Cl. A01K 1/02; A01K 29/00; A01K 11/00; B63C 9/03

(52) U.S. Cl. CPC A01K 1/0245; B63C 9/03; A01K 11/008; A01K 29/00

(57) ABSTRACT

A portable, floating animal carrier system and method of use are presented herein. More specifically, and without limitation, this disclosure relates to a portable, floating, easy to assemble pet carrier system for rescuing a pet and/or animal and allowing the pet and/or animal to be within the confines of a container. The container floats over water in emergency and other situations such as during flooding, hurricanes, boating emergencies and more. The disclosure herein also includes, but is not limited to a portable, floating retrofit system, and related method of use.

### CROSS-REFERENCE TO RELATED APPLICATIONS

The present application claims priority to U.S. Provisional Patent Application No. 62/903,912 which was filed on Sep. 22, 2019, which is hereby incorporated by reference herein in its entirety, including any figures, tables, or drawings.

### FIELD OF THE DISCLOSURE

This disclosure relates to a portable floating pet carrier system. More specifically and without limitation, this disclosure relates to a portable floating pet carrier system for rescuing a pet and allowing the pet to be within the confines of a container which floats over water in emergency and other situations such as during flooding, hurricanes, boating emergencies and more, a retrofit system, and related method of use.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Melissa Torres. All rights reserved. Trisha Torres. All rights reserved.

### BACKGROUND OF THE DISCLOSURE

Animal carriers and/or pet carriers are well known in the art. Animal carriers are used to transport animals from place to place. Pet carriers are generally a small portable box, crate, or cage used to transport small animals such as cats, dogs, pigs, ferrets, chickens, and other pets. Oftentimes pet carriers are used to transport animals to a veterinarian office and/or other location. Pet carriers make transporting an animal inside a car or truck easier because, usually, the animal cannot move about within the car or truck once inside the carrier.

Emergencies and natural catastrophes such as floods, earthquakes, hurricanes, cyclones, boating emergencies, shoreline emergencies, and the like are occurring more and more frequently over the recent years due to climate change and other factors. More and more communities are located along shores and/or where these events occur. When natural and unnatural calamities occur, it is often unsafe to be outdoors and thus humans and animals seek safety and/or shelter.

Conventional animal shelter, including but not limited to dog houses and the like, does not provide adequate protection to an animal during a natural disaster and/or emergency. Furthermore, in the event of flooding or a water swell, which is common in hurricane situations, conventional animal shelters do not provide a means of floatation or other safety features for stranded animals. Thus there is a need for improved animal carriers.

Animal rescue groups are often deployed to areas of emergency, such as areas that were recently hit by hurricanes and the like, after a hurricane has made landfall because thousands and often tens of thousands of animals die in these catastrophic events. It is estimated that in 2005, after hurricane Katrina made landfall, that over 600,000 animals were found dead. Furthermore, a lot of owners, while they don't leave pets behind in these circumstances are forced to swim or boat away from these emergencies without having any way to keep their pets afloat. Thus there is a need for improved animal carriers.

### SUMMARY OF THE DISCLOSURE

A portable floating animal carrier system is presented having a buoyant feature, and method of use is presented herein. More specifically, and without limitation, the disclosure herein presents a retrofit system for attachment to existing pet carriers. More specifically, and without limitation, the disclosure herein is meant to house animals with human interaction and provide a retrofit system, not meant to house animals indefinitely or without human interaction. More specifically, and without limitation, the disclosure herein presents a means to transport an animal in any situation in which flooding has or is expected to occur as with a hurricane, storm surge, flash floods, and/or other water emergency.

Furthermore, in addition to presenting a retrofit system which enables pet owners to transform an existing pet carrier into a floating carrier which enables the owner to transport an animal in any situation in which flooding has occurred, an electronic registry is disclosed herein. More specifically, the electronic registry disclosed herein provides pet owners, vets, and others a registration system and tag system that allows owners to register pet information and others to identify information about the pet.

Furthermore, the retrofit system herein, also includes a means for attaching multiple floating pet carriers and/or retrofit systems together. In this way, multiple floating pet carriers can be strung together and controlled by a pet owner. In other words, the system disclosed herein also provides a solution for a pet owner that owns multiple pets as opposed to a single pet. In this way, owners and/or responders could string together a raft (or train) of carriers that could easily be pulled through the water by one person at the head of the procession. Furthermore, rather than a person pulling the pet carrier, or plurality of pet carriers, through the water, a boat or other watercraft could tow the carriers utilizing the disclosure herein.

The pet carrier and/or retrofit system for a pet carrier presented herein provides a novel way for transporting a pet which can be used in emergencies and accommodated by various transportation methods once the pet carrier is picked up. Some of these transportation methods which the unique system presented herein can be accommodated by include airline transportation, human transportation by carrying, car transportation, and the like. The system herein can float on water and be transported by any and/or a combination of these methods and more once recovered and/or even if not recovered. In this way, the system presented herein offers both safety and flexibility.

Thus, it is a primary object of the disclosure to provide a quick change small footprint testing system and method of use that improves upon the state of the art.

Another object of the disclosure is to provide a portable floating animal carrier system and method of use that is safe to use.

Yet another object of the disclosure is to provide a portable floating animal carrier system and method of use that is flexible and can be easily transported.

Another object of the disclosure is to provide a portable floating animal carrier system and method of use that can be adapted to a variety of transportation means.

Yet another object of the disclosure is to provide a portable floating animal carrier system and method of use that can float on water.

Another object of the disclosure is to provide a portable floating animal carrier system and method of use that can keep water out.

Yet another object of the disclosure is to provide a portable floating animal carrier system and method of use that can accommodate a variety of sizes of containers for a variety of sizes of animals.

Another object of the disclosure is to provide a portable floating animal carrier system and method of use that is safe to use.

Yet another object of the disclosure is to provide a portable floating animal carrier system and method of use that is easy to use.

Another object of the disclosure is to provide a portable floating animal carrier system and method of use that is quick to assemble.

Yet another object of the disclosure is to provide a portable floating animal carrier system and method of use that is easy to store.

Another object of the disclosure is to provide a portable floating animal carrier system and method of use that can be onboarded and quickly dispatched.

Yet another object of the disclosure is to provide a portable floating animal carrier system and method of use that is durable.

Another object of the disclosure is to provide a portable floating animal carrier system and method of use that is high quality.

Yet another object of the disclosure is to provide a portable floating animal carrier system and method of use that has an emergency beacon.

Another object of the disclosure is to provide a portable floating animal carrier system and method of use that has a gps location system.

Yet another object of the disclosure is to provide a portable floating animal carrier system and method of use that can be seen at night.

Another object of the disclosure is to provide a portable floating animal carrier system and method of use that is difficult to tip upside down.

Yet another object of the disclosure is to provide a portable floating animal carrier system and method of use that increases the likelihood of survival of an animal in a calamity situation.

Another object of the disclosure is to provide a portable floating animal carrier system and method of use that is lightweight.

Yet another object of the disclosure is to provide a portable floating animal carrier system and method of use that can be used multiple times.

Another object of the disclosure is to provide a portable floating animal carrier system and method of use that protects an animal on the interior.

Yet another object of the disclosure is to provide a portable floating animal carrier system and method of use that keeps an animal dry.

Another object of the disclosure is to provide a portable floating animal carrier system and method of use that has a door that can be easily opened and closed.

Yet another object of the disclosure is to provide a portable floating animal carrier system and method of use that may include a water membrane.

Another object of the disclosure is to provide a portable floating animal carrier system and method of use that is comfortable for a variety of animals.

Yet another object of the disclosure is to provide a portable floating animal carrier system and method of use that can be transported within the cargo hold of an airplane.

Another object of the disclosure is to provide a portable floating animal carrier system and method of use that can be transported in the cabin area of an airplane.

Yet another object of the disclosure is to provide a portable floating animal carrier system and method of use that is ventilated.

Another object of the disclosure is to provide a portable floating animal carrier system and method of use that does not bend under pressure.

Yet another object of the disclosure is to provide a portable floating animal carrier system and method of use that keeps the animal upright.

Another object of the disclosure is to provide a portable floating animal carrier system and method of use that is value priced.

Yet another object of the disclosure is to provide a portable floating animal carrier system and method of use that can be transported in a land vehicle.

Another object of the disclosure is to provide a portable floating animal carrier system and method of use that can also be used as a pet bed.

Yet another object of the disclosure is to provide a portable floating animal carrier system and method of use that increases safety for both animals and users.

Another object of the disclosure is to provide a portable floating animal carrier system and method of use that increases the safety of first responders.

Yet another object of the disclosure is to provide a portable floating animal carrier system and method of use that can be lifted by a winch to a helicopter.

Another object of the disclosure is to provide a portable floating animal carrier system and method of use that does not require inflation.

Yet another object of the disclosure is to provide a portable floating animal carrier system and method of use that can be used to rescue animals.

Yet another object of the disclosure is to provide a portable floating animal carrier system and method of use that can be used by users of all ages, including children and elderly.

Another object of the disclosure is to provide a portable floating animal carrier system and method of use that includes safety lights and other safety features.

Yet another object of the disclosure is to provide a portable floating animal carrier system and method of use that includes a beacon.

Another object of the disclosure is to provide a portable floating animal carrier system and method of use that enables a user to navigate a pet over water during a water emergency.

These and other objects, features, or advantages of the present disclosure will become apparent from the specification and claims.

### BRIEF DESCRIPTION OF THE DRAWINGS

FIG. 1 is a top, perspective view showing the portable floating animal carrier system and method of use; the view showing a container; the view showing a seal system; the view showing a flotation system; the view showing an emergency beacon system;

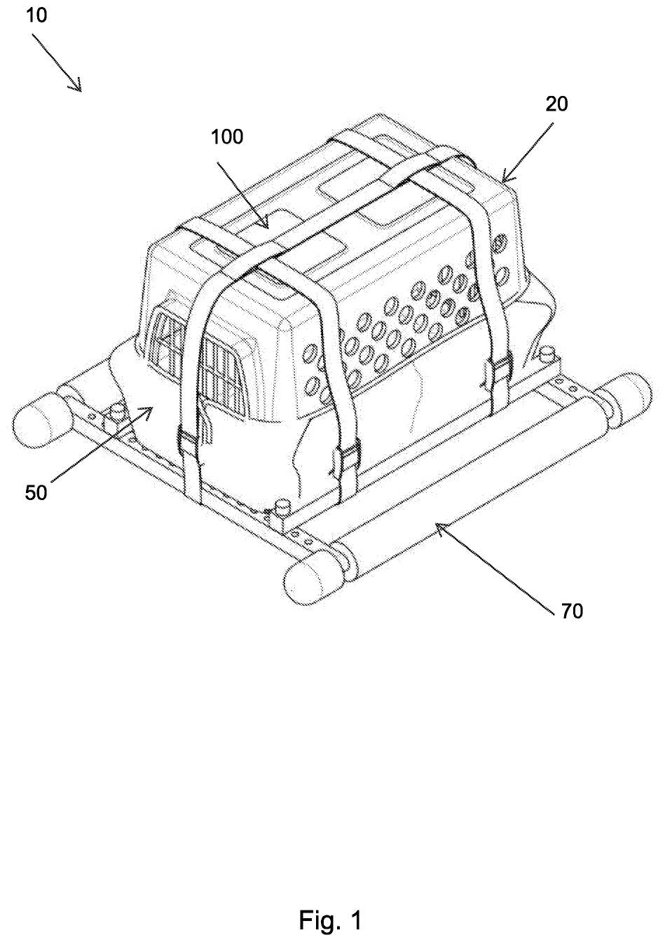

FIG. 2 is a front, elevation view showing the portable floating animal carrier system and method of use; the view showing a hollow interior; the view showing a container; the view showing a seal system; the view showing a flotation system; the view showing an emergency beacon system;

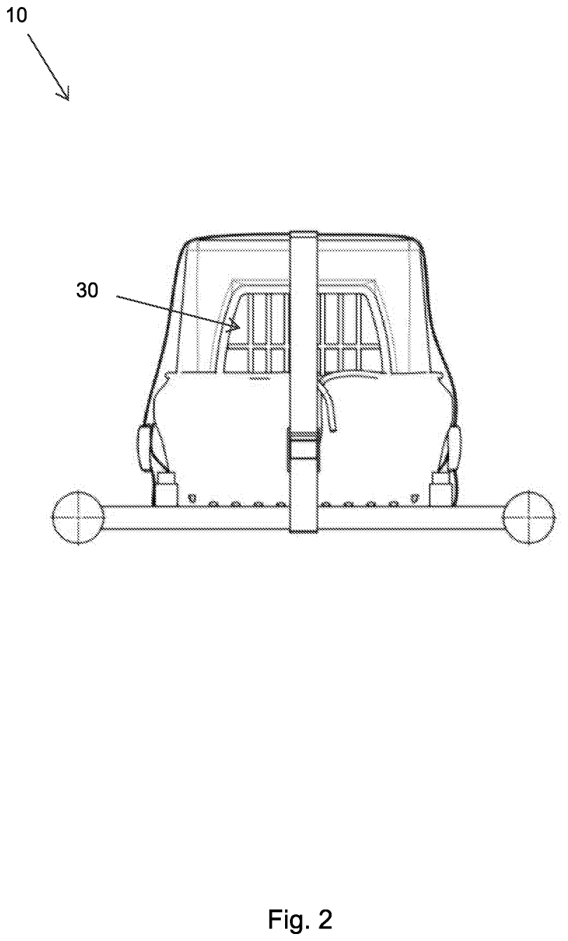

FIG. 3 is a side, elevation view showing the portable floating animal carrier system and method of use; the view showing the sidewall of the container; the view showing the first end of the container; the view showing the second end of the container; the view showing the top of the container; the view showing apertures of the container; the view showing a container; the view showing a seal system; the view showing a flotation system; the view showing an emergency beacon system;

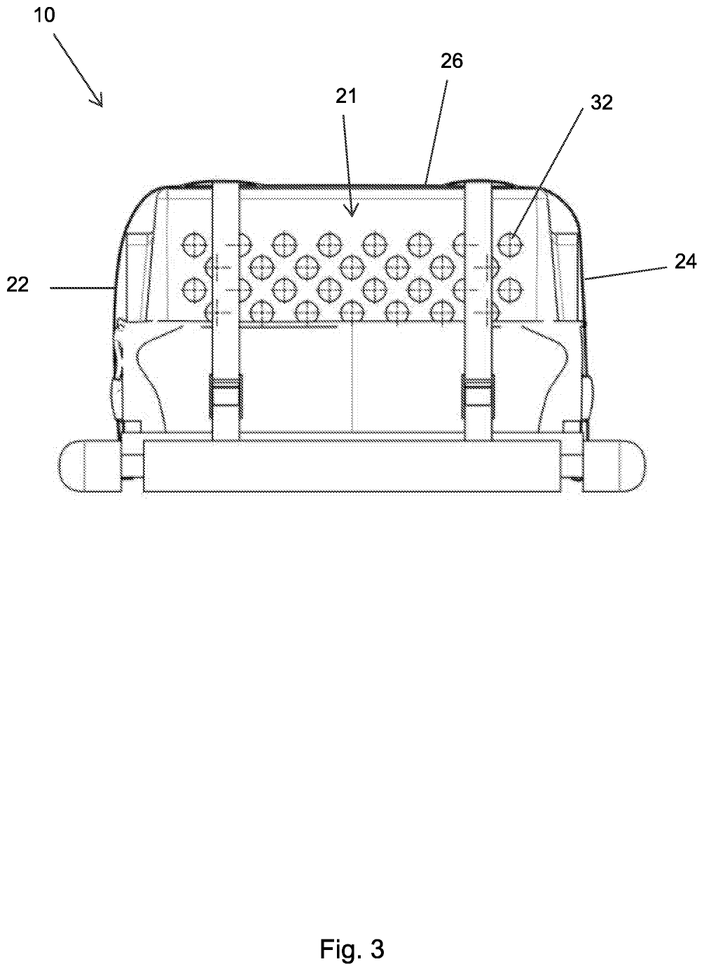

FIG. 4 is a side, elevation view showing the portable floating animal carrier system and method of use; the view showing a container; the view showing a seal system; the view showing a flotation system; the view showing an emergency beacon system;

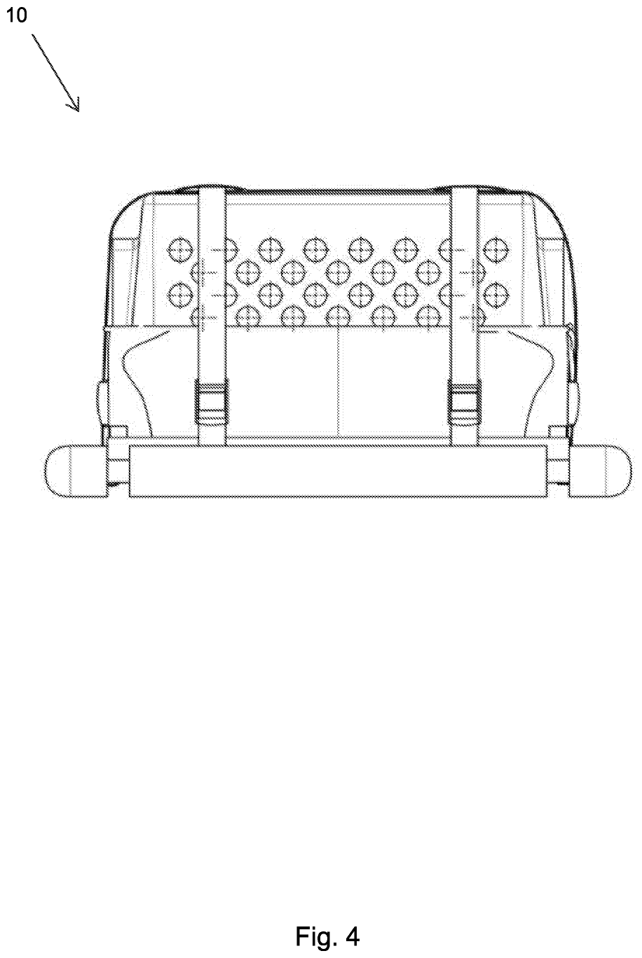

FIG. 5 is a top view showing the portable floating animal carrier system and method of use; the view showing the upper housing of the container; the view showing the lip of the upper housing of the container; the view showing a plurality of attachment features of the upper housing; the view showing a plurality of attachment features of the lower housing; the view showing a container; the view showing a seal system; the view showing a flotation system; the view showing an emergency beacon system;

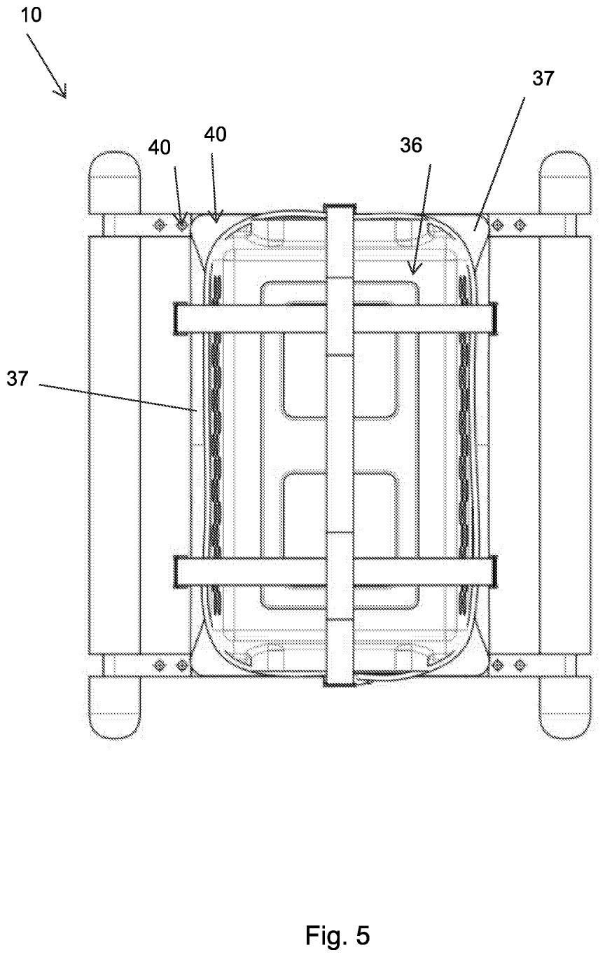

FIG. 6 is a bottom view showing the portable floating animal carrier system and method of use; the view showing the bottom of the container; the view showing the lower housing of the container; the view showing the lip of the lower housing of the container; the view showing a container; the view showing a seal system; the view showing a flotation system; the view showing an emergency beacon system;

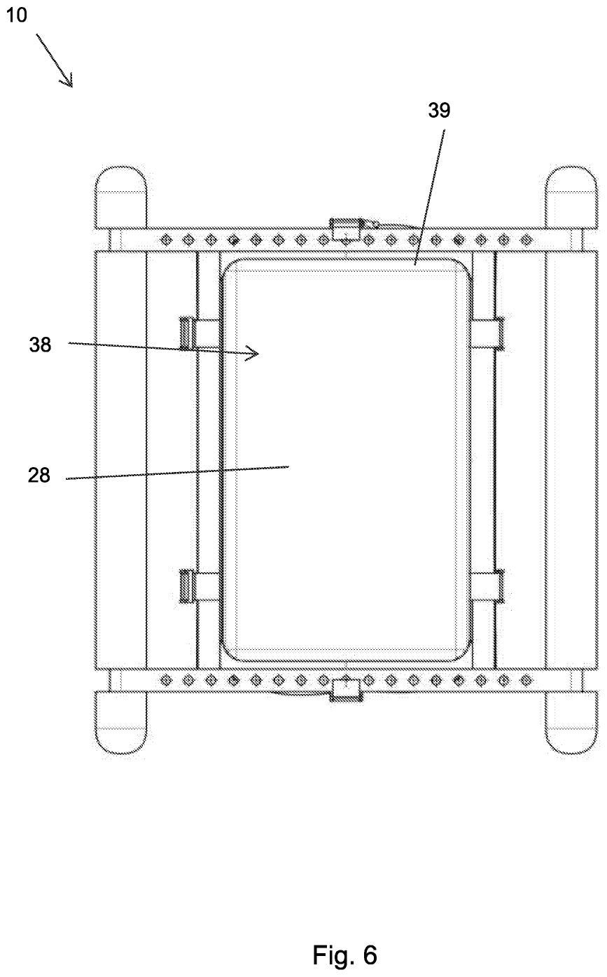

FIG. 7 is a rear, elevation view showing the portable floating animal carrier system and method of use; the view showing a door of the container; the view showing a container; the view showing a seal system; the view showing a flotation system; the view showing an emergency beacon system;

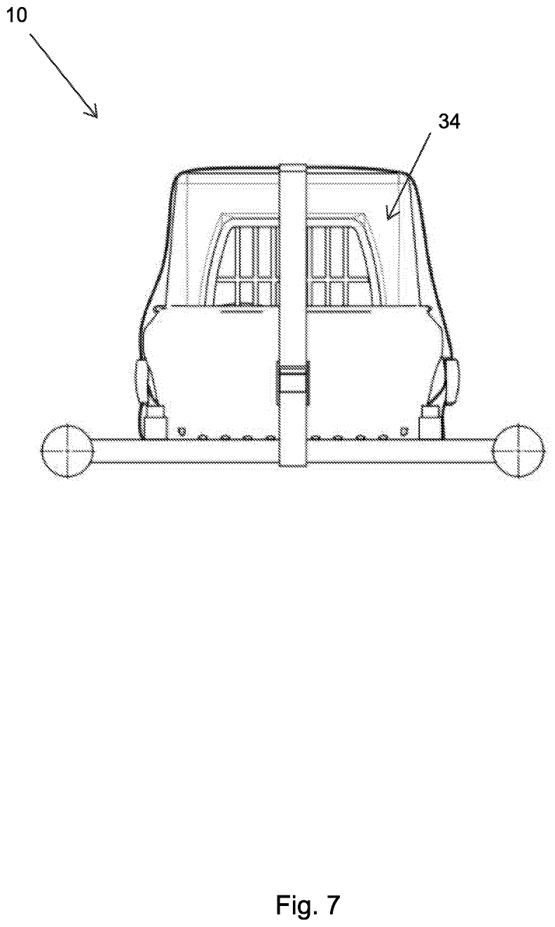

FIG. 8 is a bottom, perspective view showing the portable floating animal carrier system and method of use; the view showing a membrane of the seal system; the view showing a draw string of the seal system; the view showing a draw string loop of the seal system; the view showing an emergency beacon system; the view showing a container; the view showing a seal system; the view showing a flotation system; the view showing an emergency beacon system;

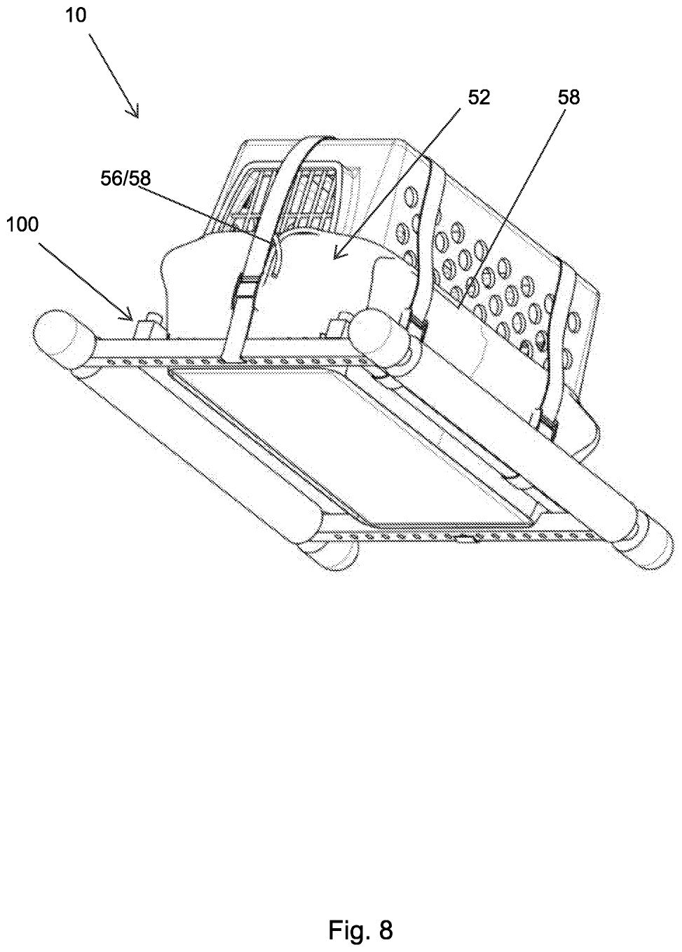

FIG. 9 is a top, perspective view showing the portable floating animal carrier system and method of use; the view showing an emergency beacon system; the view showing a light feature of the emergency beacon system; the view showing a gps feature of the emergency beacon system; the view showing an antenna of the emergency beacon system; the view showing a transceiver of the emergency beacon system; the view showing an attachment feature of the emergency beacon system; the view showing an information system of the emergency beacon system; the view showing a container; the view showing a seal system; the view showing a flotation system;

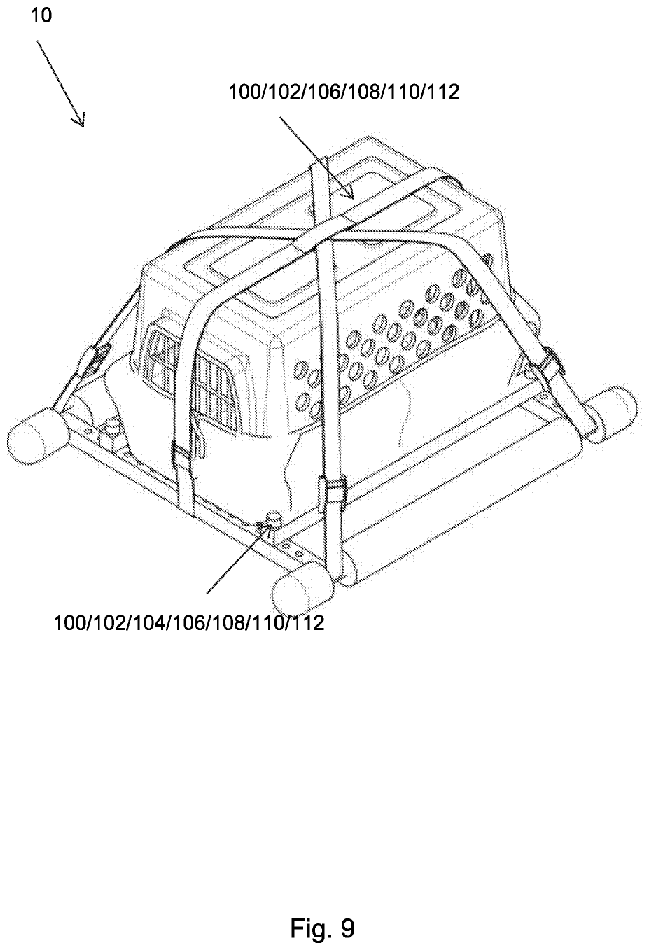

FIG. 10 is a front, elevation view showing the portable floating animal carrier system and method of use; the view showing a container; the view showing a seal system; the view showing a flotation system; the view showing an emergency beacon system;

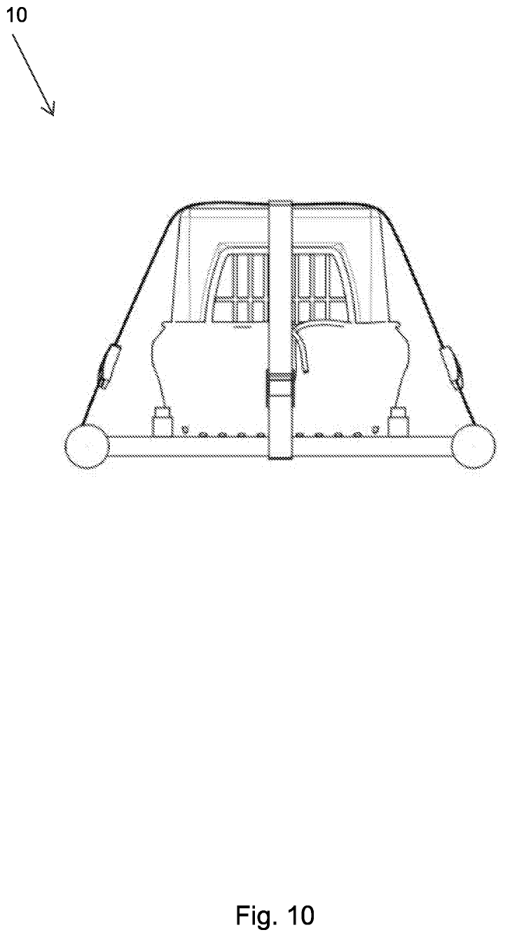

FIG. 11 is a side, elevation view showing the portable floating animal carrier system and method of use; the view showing a container; the view showing a seal system; the view showing a flotation system; the view showing an emergency beacon system;

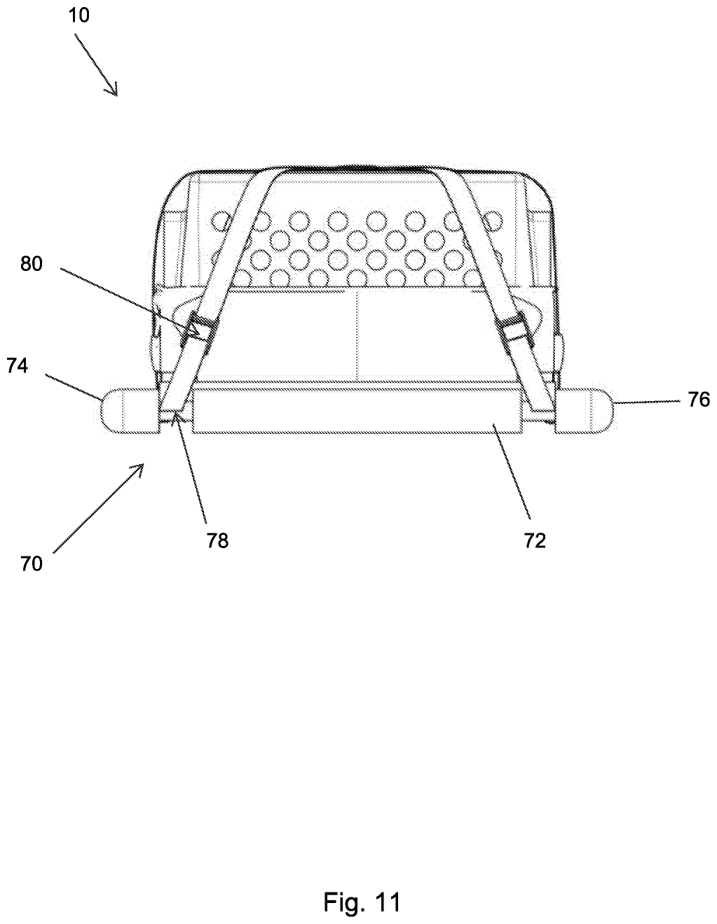

FIG. 12 is a side, elevation view showing the portable floating animal carrier system and method of use; the view showing a container; the view showing a seal system; the view showing a flotation system; the view showing an emergency beacon system;

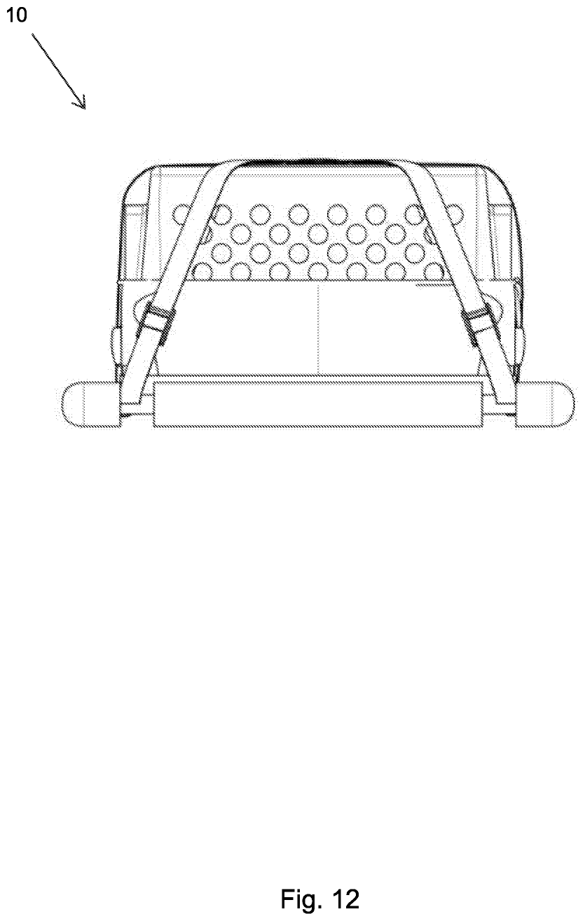

FIG. 13 is a top view showing the portable floating animal carrier system and method of use; the view showing a strap system; the view showing a connection feature of a strap system; the view showing a plurality of ratchets of the strap system; the view showing a plurality of reflective features of the strap system; the view showing an anti-roll feature of the strap system; the view showing a container; the view showing a seal system; the view showing a flotation system; the view showing an emergency beacon system;

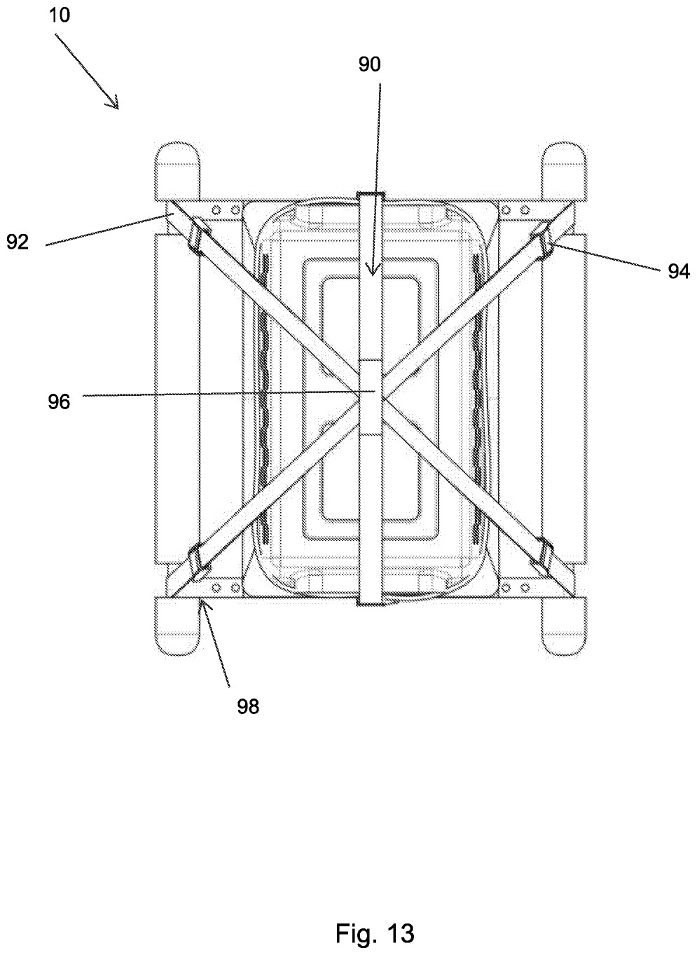

FIG. 14 is a bottom view showing the portable floating animal carrier system and method of use; the view showing a flotation system; the view showing a frame of the flotation system; the view showing a box of the frame of the flotation system; the view showing a plurality of extension features of the flotation system; the view showing a plurality of adjustment features of the flotation system; the view showing a container; the view showing a seal system; the view showing an emergency beacon system;

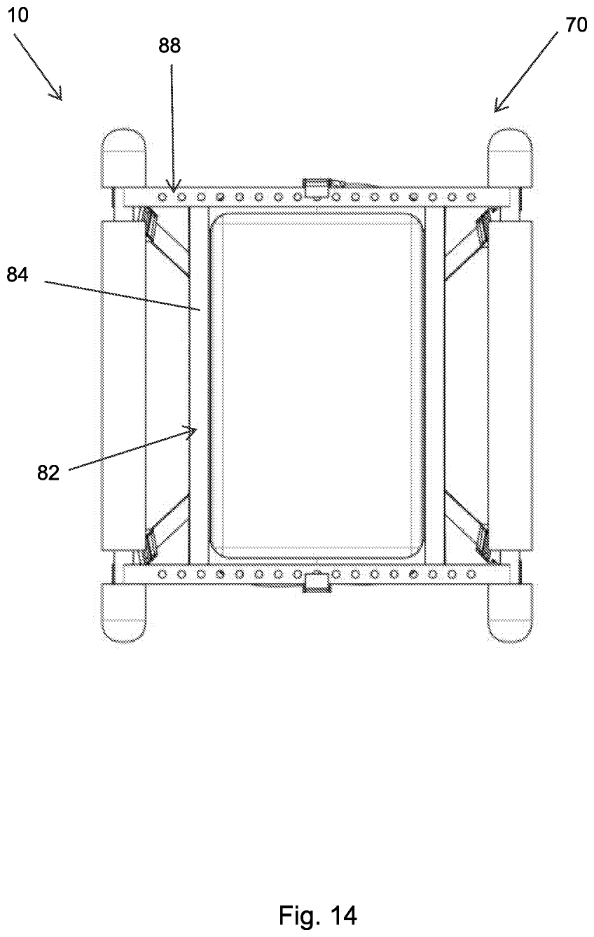

FIG. 15 is a front, elevation view showing the portable floating animal carrier system and method of use; the view showing a container; the view showing a seal system; the view showing a flotation system; the view showing an emergency beacon system; the view showing a strap system;

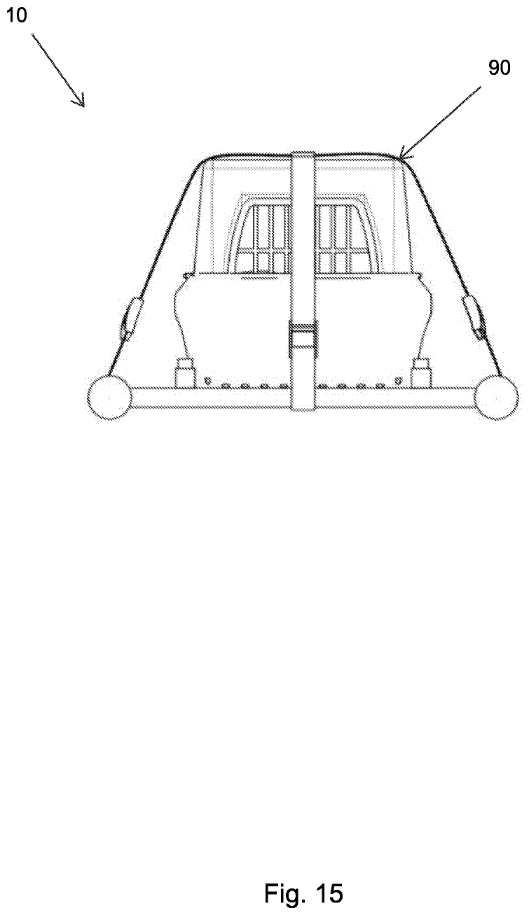

FIG. 16 is a bottom, perspective view showing the portable floating animal carrier system and method of use; the view showing a container; the view showing a seal system; the view showing a flotation system; the view showing an emergency beacon system.

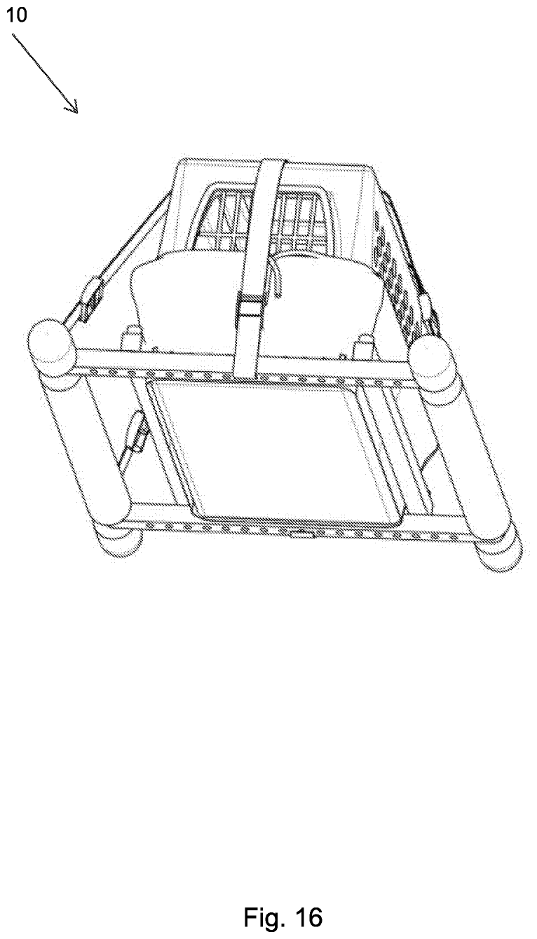

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

With reference to the figures, a system is presented. The system 10, as presented herein, enables pet and/or animal owners to transport their pets and/or animals over water in a safe and protected enclosure. The system herein also includes a kit, as an alternative embodiment, which can be retrofit to other pet carriers.

System:

With reference to the figures, a portable floating animal carrier system 10 (also known as “system”, “retrofit system”, “animal system”, “pet system”, and “transport system”) and method of use are presented. System 10, as presented herein, enables a pet owner to transport their pets over water in the event of a water emergency, as well as other various uses as will become apparent. System 10 is formed of any suitable size, shape, and design and is configured to provide a container for the pet to be stored within, shelter the pet and/or animal from the elements, and float on the surface of the water, allowing the pet and/or animal to remain afloat in a water event.

In the arrangement shown, as one example, system 10 includes a container 20, a membrane system 50, a floatation system 70, and a location system 100, among other components, features, and functionality.

Container:

In the arrangement shown as one example, system 10 includes a container 20 (also known as “main body”). Main body 20 may be formed of any suitable size, shape, and design and is configured to house the pet and/or animal. In other words, container 20 is configured to provide shelter around the animal and/or pet.

In the arrangement shown, as one example, container 20 is a common pet carrier. The pet carrier extends a length from a first end 22 to a second end 24. The pet carrier also has a generally flat top 26 and a generally flat bottom 28. The pet carrier is generally rectangular and/or box-like having four sidewalls 21. The sidewalls 21 creating a perimeter and/or hollow interior 30 when combined with the top 26 and the bottom 28.

Additionally, in the arrangement shown, as one example, the pet carrier is formed from the combination of an upper housing 36 having a lip 37 and a lower housing 38 having a lip 39. In this way, the upper housing 36 includes four generally flat sidewalls 21 which are attached to a generally flat top 26 and oriented perpendicular thereto, extending downward therefrom. Sidewalls 21 of the upper housing 36, extend halfway between the top 26 of the container 20 and the bottom 28 of the container 20. Adjoining the sidewall and at the bottom of the upper housing is a lip 37 which extends perpendicularly from the sidewall 21 in an outwardly direction such that the lip 37 provides a means of connecting the upper housing 36 to the lower housing 38.

Similarly, in the arrangement shown, as one example, lower housing 38 includes a lip 39. Lower housing 38 includes four generally flat sidewalls 21 which are attached to a generally flat bottom 28 and oriented perpendicular thereto, extending upward therefrom. Sidewalls 21 of the lower housing 38, extend halfway between the bottom 28 of the container 20 and the top 26 of the container 20. Adjoining the sidewall 21 and at the top of the lower housing 38 housing is a lip 39 which extends perpendicularly from the sidewall 21 in an outwardly direction such that the lip 39 provides a means of connecting the lower housing 38 to the upper housing 36.

In the arrangement shown, as one example, container 20 is formed from a common pet carrier which comprises two main portions, being an upper housing 36 and a lower housing 38 which form a hollow interior 30 which houses and holds an animal within. However, any other container 20 is hereby contemplated for use which is configured to shelter an animal and/or a pet from the elements. Another example of a container 20 may be, but is not limited to, a container which is circular, spherical, and or otherwise configured to hold an animal and/or pet within while shielding elements from the outside. Additionally, in the arrangement shown, as one example, the plurality of sidewalls 21, the top 26, the bottom 28, and other container 20 components are formed of a polymer. However, any other material which is adequate and durable for blocking elements and protecting an animal and/or pet within is hereby contemplated for use including metal, carbon, composites, enhanced polymers, and the like.

Attachment Features: In the arrangement shown, as one example, container 20 includes an attachment feature 40. Attachment feature 40 is formed of any suitable size, shape, and design and is configured to attach the upper housing 36 to the lower housing 38. In the arrangement shown, as one example, attachment features 40 are formed of nuts and bolts, wherein the bolts extend vertically through a plurality of apertures located around the length and/or circumference of the lip 37/39.

In the arrangement shown, as one example, attachment features 40 are formed of nut and bolt attachments. However, other types of attachment features are hereby contemplated for use including clips, adhesives, fasteners, frictional fitting, molding, a combination therein and the like. Additionally, the container 20 may be formed of a unitary construction and not require fitting and/or attaching of a lower and upper housing. However, a unitary construction may not be desirable for transportation of the container 20 as the construction shown, as one example, allows the upper housing 36 to fit within the lower housing 38, or vise-versa, which causes the container 20 to take up less space in transport and/or storage.

Door Assembly: In the arrangement shown, as one example, container 20 includes a door 34. Door 34 is formed of any suitable size, shape, and design and is configured to enclose an animal and/or pet within the hollow interior 30 of the container 20. In the arrangement shown, as one example, door 34 is configured to hingedly open and close and lock in place in the closed position such that an animal and/or pet can be locked within the hollow interior 30 of the container 20. In this way, the animal and/or pet can be left alone within the hollow interior 30 of the container 20 and not escape and/or be frightened into being lost or otherwise.

In the arrangement shown, door 34 is configured by a cross mesh of metal wire and is located at the end of the container 20. Said another way, the door 34 shown in the arrangement is formed of a plurality of small gauge metal bars overlapping in a grid pattern. In this way, holes still allow air movement into, and out of, the hollow interior 30 of the container 20, while the grid contains animals and/or pets, keeping them held within the hollow interior 30 of the container 20.

In the arrangement shown, as one example, door 34 is generally square in shape. In the arrangement shown, as one example, door 34 consists of most of one end of the container 20. In addition, in the arrangement shown, only one door is shown as one end of the container 20. However, any number of doors is contemplated for use, including one door, two doors, three doors, four doors, or more. The positioning of these doors may be one located on each end. A plurality located on each end; A smaller access door located on a sidewall 21, and the like.

Also, while the arrangement shown, as one example, shows a metal grid door, any other form of a door and/or blockade is hereby contemplated for use. Other forms of a door include, but are not limited to, a flat panel, a partial door, and the like. Additionally, while a hinged door is shown with a bar lock which extends through an aperture of the container 20, any other form of a door is hereby contemplated for use including, but not limited to, doors that slide open and/or close, doors that frictionally fit, doors that are temporary, a combination of those herein, as well as other functioning doors. Finally, the lack of a door or simply an opening in place of a door is also hereby contemplated for use.

In the arrangement shown, as one example, door 34 is made of round, circular small gauge, overlapping metal tubes which create a grid of metal. However, other materials for door assembly 34 are hereby contemplated for use. Other materials for door assembly 34 construction include, but are not limited to, polymers, sheet polymer and/or tube polymers, metal alloys, composites, card-board, and the like.

Apertures: In the arrangement shown, as one example, container 20 includes a plurality of apertures 32. Apertures 32 are formed of any suitable size, shape, and design and are configured to create access for air flow and visual line of sight from the outside of the container 20 to the inside of the container and vise-versa. In the arrangement shown, as one example, apertures appear in the upper housing 36 of the sidewall 21. Apertures 32 comprise a plurality of small openings, strengthened by small-gauge metal. Other forms of openings, including circular openings that allow air flow and line of sight are also contemplated for use, such that apertures improve safety of the pet and/or animal within.

Membrane System:

In the arrangement shown, system 10 includes a membrane system 50. Membrane system 50 is formed of any suitable size, shape, and design and is configured to provide a water barrier to prevent water from entering the hollow interior 30 of the container. In the arrangement shown, as one example, membrane system 50 is formed of a 7 mil polyethylene sheet which is tied around the circumference of the container 20 by a drawstring 56, and held in place vertically by the lips 37/39.

Membrane: In the arrangement shown, as one example, membrane system 50 includes a membrane 52. Membrane 52 is formed of any suitable size, shape, and design and is configured to provide the waterproof barrier which does not allow water to pass. In this way, membrane 52 can be formed around the lower half of the container, providing a wrap which prevents water leakage. Polyethylene is advantageous because it absorbs almost no water and allows almost no water to penetrate, however other materials are hereby contemplated for use which prevent water leakage into the hollow interior 30 of the container.

Drawstring: In the arrangement shown, as one example, membrane system 50 includes a drawstring 56. Drawstring 56 is formed of any suitable size, shape, and design and is configured to secure the membrane system in place around all and/or a portion of the container 20 and/or system 10. In the arrangement shown, as one example, drawstring 56 is in a draw string loop 58 which is formed by folding the end of a sheet of polyethylene over and heat sealing the draw string in place. In this way, drawstring 56, as a small rope is able to securely, and snuggly, afix the membrane 52 around the container.

In the arrangement shown, drawstring 56 is formed of a small gauge rope. However, other materials for drawstring 56 are hereby contemplated for use. Drawstring 56 itself, may be made of polyethylene. Furthermore, membrane 52 may be attached to the container 20 and/or system 10 in any suitable attachment, either directly as a unitary construction, by heat sealing, by stamping, pressing, buttoning, frictional fitting, any combination thereof, and the like.

Flotation System:

In the arrangement shown, system 10 includes a flotation system 70. Flotation system 70 is formed of any suitable size, shape, and design and is configured to keep container 20 and/or pet and/or animal floating in a water event. Said another way, the flotation system 70 provides access to shelter and oxygen for an animal and/or pet housed within the hollow interior 30 of the container 20.

Flotation Device: In the arrangement shown, as one example, flotation system 70 includes at least one flotation device 72. Flotation device 72 may be formed of any suitable size, shape, and design and is configured to keep the container afloat by providing a buoyant feature for floatation system 70 which causes flotation system 70 to stay atop and/or near the surface of the water.

In the arrangement shown, as one example, flotation device 72 is formed of longitudinal polyethylene foam extending from a first end 74 to a second end 76. Additionally, in the arrangement shown, as one example, flotation device 72 is hollow such that rope and or piping can be looped through the entire hollow interior 77 of the flotation device 72. In the arrangement shown, as one example, flotation device 72 is formed of polyethylene foam which is a strong, resilient closed-cell foam. Because the foam is closed-cell, the air is stored within the cell. Polyethylene foam is also very lightweight because it is formed of pockets of air. In this way, polyethylene foam, which displaces large volumes of space while being lightweight, creates an intense buoyant effect.

Although, longitudinal tubes of polyethylene foam are used herein for a plurality of flotation devices 72 as part of flotation system 70, other forms of flotation devices 72 are hereby contemplated for use, such that have a buoyant property and can contribute to the flotation of system 10. Other examples include, but are not limited to, polymer tubes filled with air, and other flotation devices which can be attached to container 20.

Attachment Feature: In the arrangement shown, as one example, flotation system 70 includes an attachment feature 78. Attachment feature 78 may be formed of any suitable size, shape, and design and is configured to attach the flotation device 72 to flotation system 70. Additionally, attachment features 78 are configured to attach flotation devices to container 20. In the arrangement shown, attachment features 78 include a metal tubing which frictionally fits the flotation device 72 in close and secure proximity with the container. In another arrangement, as is shown, attachment feature 78 includes an entire aluminum box system created to extend flotation devices 72 unilaterally away from container 20, such that the flotation devices 72 are utilized in a way which prevents tipping and or rocking of container 20.

In the arrangement shown, as one example, attachment features 78 may also include ropes and/or straps and/or ratchets which aid in wrapping the flotation devices 72 against the sidewall 21 of the container 20. Additionally, and in another embodiment shown, attachment features 78 include a strap system 90 which attaches a frame 82 to the container 20.

Other features and or components of attachment features include, but are not limited to, attachment adjustment features, attachment frame features (of varying sizes and dimensions), box feature, extension feature, adjustment features, strap system, connection features, a plurality of ratchets, a reflective feature, and an anti-roll feature, among other features and components.

Beacon/Identification System:

In the arrangement shown as one example, system 10 may include a beacon system 100 and/or identification system 100. Beacon system 100 is formed of any suitable size, shape, and design and is configured to help locate and/or identify information related to system 10. Beacon system 100 may include location features, light features, and identification features.

Said another way, beacon system 100 may include features and functionality which help one locate system 10. Beacon system 100 may also include features and functionality which help one identify information related to the container 20 and/or contents of that container. In other words, beacon system 100 may include an identification tag and/or other means of relaying information about the contents including an RFID tag or other means which might relay information including what type of animal is housed within the container, the name of the animal housed, if the animal is friendly to humans, the age of the animal, allergens of the animal, owner information and more.

Light Feature: In the arrangement shown, as one example beacon system 100 includes at least one light feature 102. Light feature 102 is formed of any suitable size, shape and design and is configured to provide a visual indicator to others that there are important contents within the container. In other words, light feature 102 is designed to create a beacon and or transmit and communicate with others information, whether it be the location of system 10 or the like.

GPS Feature: Beacon system 100 may also include a GPS feature 104. GPS feature 104 is formed of any suitable size, shape, and design and is configured to communicate to a user the global position of system 10. In this way, GPS feature 104 may include an antenna, a transceiver, and other electronic components, including a power source, that allow the beacon system 100 to effectively send a signal and/or communicate the global position of the container 20 to a remote user.

Information System: Beacon system 100 may also include an information system 112. Information system 112 is formed of any suitable size, shape, and design and is configured to communicate and/or relay information about the container 20 and or contents within the container 20 to an identifier and/or finder. As one example of an information system 112.

Among other components and features, system 10 may also include a component which auto-releases the door in the event of flooding and or cap-sizing, such that the animal and/or pet can escape in an emergency.

In Operation/Method of Use:

As one example, system 10 is a pet rescue raft designed to enable pet owners to easily transport their pets over water, protecting the pet from getting wet or from debris that may be present in the water during natural disasters.

In this way, as one example, system 10 consists of a container 20 which houses a pet and/or animal. Attached to the container is a flotation system which keeps the container 20 afloat. Additionally, other features may also be attached to system 10.

As one use, when an emergency or water event occurs and an owner needs to evacuate shelter, a pet owner may place a pet within the container 20. In the arrangement shown, a container 20 may need to be assembled by quickly. Once assembled, a pet and/or animal can be placed inside by opening the door. The door can then be closed to contain the pet and/or animal within the hollow interior of the container.

Once a pet is secure on the inside, a membrane system can be secured around the container 20. In the arrangement shown, as one example, the membrane system is located around the lower half. In this arrangement, the membrane system should be raised around the lower half of the container and tightened with the drawstring once in place. In this way, the drawstring will hold the membrane in place and the pet and/or animal within will be kept dry and comfortable.

Once the membrane system is securely in place, the flotation system should be attached to the container. In one arrangement, as is shown, a flotation system is slid over the membrane and fits in close and tight tolerances around the lower housing. In this way, the flotation system will be held in place by both frictional fit and buoyant force. Additionally a strap may be used which loops through the plurality of flotation devices and wraps around the entirety of the container, thus holding the flotation system in place around the container.

In another arrangement, as is shown, the flotation system is held in place by a box or frame which also allows the flotation devices to be extended outwardly from the center of the container. In this way, the flotation devices can be adjusted and the distance between the flotation device and the container increased. This arrangement allows for improved horizontal leverage which prevents tipping of the container.

Once the pet and/or animal is secured within the container and the systems are ready to go, a user can guide the system across the water and to safety. In this way, system 10 will keep the pet and/or animal afloat with access to oxygen and safely secured within the shelter of system 10. Furthermore, this allows a user to transport their animals through the water while swimming. Additionally, a user can also use the system 10 to aid in their own floating if necessary. In this way, and in other ways, system 10 allows for safe and easy transport of a pet and/or animal in an emergency and/or water event.

It will be appreciated by those skilled in the art that other various modifications could be made to the device without parting from the spirit and scope of this disclosure. All such modifications and changes fall within the scope of the claims and are intended to be covered thereby.

What is claimed:

1. An animal carrier system, the system comprising:
a container;
the container extending a length from a first end to a second end;
the container having a hollow interior;
a membrane;
the membrane removably attached to the container;
wherein the membrane prevents water from entering the hollow interior of the container;
a flotation feature;
the flotation feature removably attached to the container;
a location feature.

2. The system of claim 1, further comprising:
a radio frequency identification tag.

3. The system of claim 1, further comprising:
an identification tag.

4. The system of claim 1, further comprising:
a global positioning system.

5. The system of claim 1, further comprising:
a reflective feature.

6. The system of claim 1, further comprising:
a light feature.

7. An animal carrier system, the system comprising:
a container;
the container extending a length from a first end to a second end;
the container having a hollow interior;
a membrane;
the membrane removably attached to the container;
wherein the membrane prevents water from entering the hollow interior of the container;
a flotation feature;
the flotation feature removably attached to the container;
a location feature;
an emergency beacon system.

8. The system of claim 7, further comprising:
a radio frequency identification tag.

9. The system of claim 7, further comprising:
an identification tag.

10. The system of claim 7, further comprising:
a global positioning system.

11. The system of claim 7, further comprising:
a reflective feature.

12. The system of claim 7, further comprising:
a light feature.

13. The system of claim 7, further comprising:
a transceiver;
wherein the transceiver is configured to send and receive messages through cellular communication.

14. The system of claim 7, further comprising:
a transceiver;
wherein the transceiver is configured to send and receive messages through cellular communication.

15. A method of safely transporting an animal, the steps comprising:
providing a container wherein the container has a hollow interior;
providing a water sealed membrane;
providing a flotation feature wherein the floatation feature is removably attached to the container;
providing a location feature wherein the location feature is removably attached to the container;
navigating the container over water during a water event.

16. The method of claim 15, further comprising:
placing an animal within the hollow interior of the container.

17. The method of claim 15, further comprising:
locating the container using global positioning.

18. The method of claim 15, further comprising:
filling out information on an identification tag.

19. The method of claim 15, further comprising:
providing a light feature.

20. The method of claim 15, further comprising:
providing a strap system.
